(19) United States
(12) Patent Application Publication
(10) Pub. No.: US 2020/0403419 A1
(43) Pub. Date: Dec. 24, 2020

(54) POWER MANAGEMENT SYSTEM, POWER MANAGEMENT METHOD, AND STORAGE MEDIUM

(71) Applicant: HONDA MOTOR CO., LTD., Tokyo (JP)

(72) Inventors: Shinichi Yokoyama, Wako-shi (JP); Tomohide Haraguchi, Wako-shi (JP); Naoya Yasuda, Tokyo (JP)

(73) Assignee: HONDA MOTOR CO., LTD., Tokyo (JP)

(21) Appl. No.: 17/011,082

(22) Filed: Sep. 3, 2020

Related U.S. Application Data
(63) Continuation of application No. PCT/JP2018/048192, filed on Dec. 27, 2018.

(30) Foreign Application Priority Data
Mar. 8, 2018 (JP) 2018-042257

(51) Int. Cl. H02J 7/00; H02J 13/00; G06Q 30/02; G06Q 50/06

(52) U.S. Cl. CPC H02J 7/0013; G06Q 50/06; G06Q 30/0207; H02J 13/00

(57) ABSTRACT

The present invention provides a power management system for managing a power unit, the power management system comprising: an obtaining unit configured to obtain utilization plan information of the power unit pre-registered by a user of the power unit; a creation unit configured to create an operation plan of the power unit based on the utilization plan information obtained by the obtaining unit; and a setting unit configured to set an incentive to the user according to the utilization plan information obtained by the obtaining unit.

### CROSS-REFERENCE TO RELATED APPLICATIONS

This application is a continuation of International Patent Application No. PCT/JP2018/048192 filed on Dec. 27, 2018, which claims priority to and the benefit of Japanese Patent Application No. 2018-042257 filed on Mar. 8, 2018, the entire disclosures of which are incorporated herein by reference.

### BACKGROUND OF THE INVENTION

### Field of the Invention

The present invention relates to a power management system, a power management method, and a storage medium for managing a power unit.

### Background Art

In recent years, a mechanism that controls the power demand amount by a resource aggregator for coordinating power units (power sources, resources) of a plurality of consumers, so as to meet the requirement for the power demand amount in the power market has been in the spotlight. Such a mechanism is called the demand response.

In the demand response, it is desired to operate a plurality of power units in a planned manner, according to the requirement for the power demand amount in the power market. PTL1 discloses to perform the charging and discharging control of a battery of an electric vehicle, based on the operational schedule of the electric vehicle.

In order to operate a plurality of power units in a more planned manner in the demand response, it is preferable to promptly obtain accurate utilization plans by users of the power units, and it is desired to construct a system for encouraging the users to promptly obtain the accurate utilization plans.

### CITATION LIST

### Patent Literature

PTL1: Japanese Patent No. 5666593

### SUMMARY OF THE INVENTION

The power management system according to the present invention is a power management system for managing a power unit, the power management system comprising: an obtaining unit that obtains utilization plan information of the power unit pre-registered by a user of the power unit; a creation unit that creates an operation plan of the power unit based on the utilization plan information obtained by the obtaining unit; and a setting unit that sets an incentive to the user according to the utilization plan information obtained by the obtaining unit.

In addition, the power management method according to the present invention is a power management method of managing a power unit, the method comprising: obtaining utilization plan information of the power unit pre-registered by a user of the power unit; creating an operation plan of the power unit based on the utilization plan information obtained in the obtaining of the utilization plan information; and setting an incentive to the user according to the utilization plan information obtained in the obtaining of the utilization plan information.

Further features of the present invention will become apparent from the following description of exemplary embodiments with reference to the attached drawings.

### BRIEF DESCRIPTION OF THE DRAWINGS

FIG. 1 is a diagram showing the general configuration of a VPP system.

FIG. 2A is a diagram showing the configuration of an aggregator in the VPP system.

FIG. 2B is a diagram showing the configuration of a charge station in the VPP system.

FIG. 2C is a diagram showing the configuration of a server in the VPP system.

FIG. 3 is a sequence diagram showing processing performed among the aggregator, the charge station, and a user.

FIG. 4 is a flowchart showing operation processing of a plurality of batteries in the charge station.

FIG. 5 is a diagram showing an example of the operation plans of a plurality of batteries.

FIG. 6 is a flowchart showing setting processing of an incentive.

FIG. 7A is a diagram showing an example of information used for setting the incentive.

FIG. 7B is a diagram showing an example of information used for setting the incentive.

FIG. 7C is a diagram showing an example of information used for setting the incentive.

### DESCRIPTION OF EMBODIMENTS

The embodiment of the present invention will now be described with reference to the accompanying drawings. The present invention is not limited to the following embodiments, and includes changes and modifications of arrangements within the scope of the present invention. In addition, not all the combinations of features described in the embodiments are necessarily essential to the present invention.

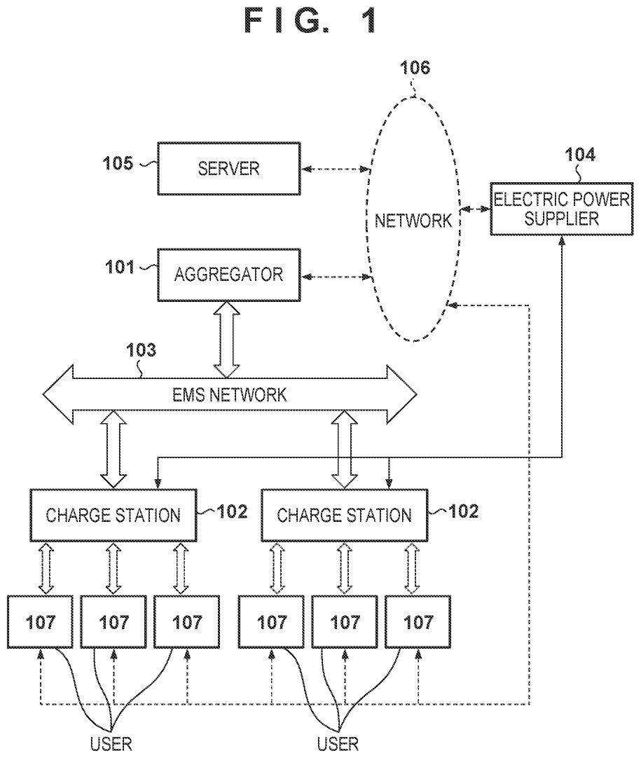

FIG. 1 is a diagram showing the general configuration of a VPP (Virtual Power Plant) system in the present embodiment. As shown in FIG. 1, the VPP system in the present embodiment includes an aggregator 101, charge stations 102, an electric power supplier 104, a server 105, and users 107. The electric power supplier 104 is, for example, a retail electric power supplier or an electric power transmission/distribution company that supplies power to consumers. A consumer means a facility itself that enjoys a VPP service, such as a home and a factory, and the charge stations 102 that manage a plurality of power units are illustrated as consumers in the present embodiment.

The charge station 102 can be a facility (management department) that stores a plurality of removable portable batteries, such as a battery mounted in an electric vehicle (EV), and a battery utilized as a power supply for home, as the plurality of power units, and individually performs charging and discharging for each of the plurality of batteries. In addition, the charge station 102 may be a facility that stores a plurality of electric vehicles (EV) themselves each including a battery as the power unit, and individually performs charging and discharging for the battery of each electric vehicle via a cable connected to each of the plurality of electric vehicles. Furthermore, the charge station 102 may be a facility that stores vehicles with a power generation unit, such as a fuel cell vehicle (FCV) and a range extender, in addition to the electric vehicles (EV), and may use electricity generated by these vehicles for the VPP system.

The aggregator 101 is located between the charge stations 102 (consumers) and the electric power supplier 104, and provides the VPP service to the users 107 utilizing the charge stations 102. In the VPP service, for example, in order to fulfill requests from the electric power supplier 104, a plurality of batteries stored in and managed by the charge station 102 are operated. The aggregator 101 integrates and controls energy management systems of the plurality of charge stations 102 in a predetermined area via an EMS network 103, and builds the VPP system. The EMS network 103 may be a dedicated line, or may include the existing telephone lines.

The server 105 manages information (hereinafter may be called “battery utilization plan information”) regarding utilization plans for the users 107 of the charge stations 102 to utilize the batteries. In addition, the aggregator 101, the electric power supplier 104, the server 105, and each user 107 are configured to be able to communicate with each other via the network 106, and can mutually transmit and receive emails and transmit and receive data, etc.

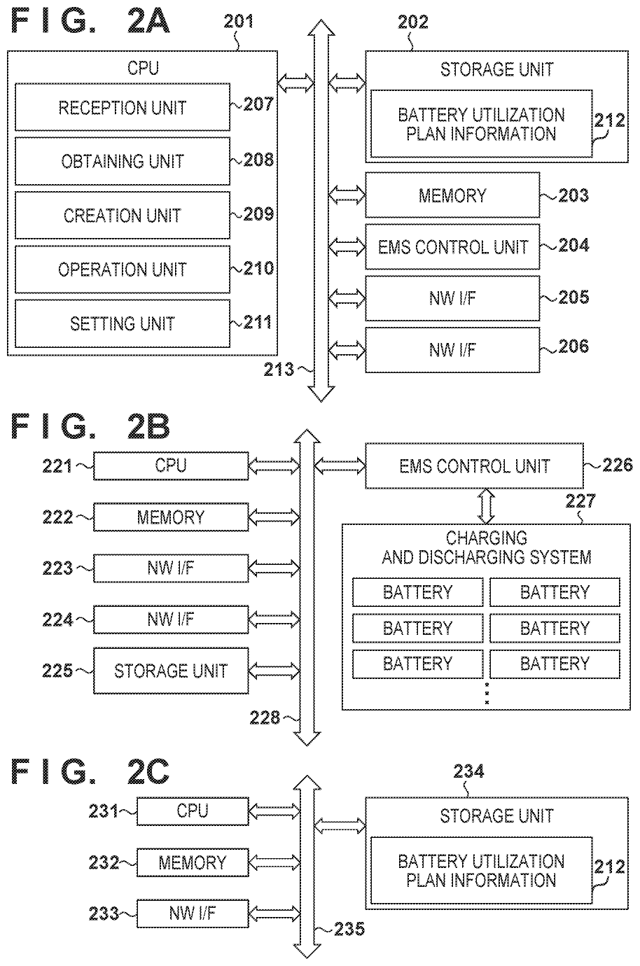

Next, referring to FIGS. 2A to 2C, each of the configurations of the aggregator 101, the charge station 102, and the server 105 is described. Each of the configurations shown in FIGS. 2A to 2C can be a computer that can execute the present invention according to a program.

FIG. 2A is a diagram showing the configuration of the aggregator 101. Each of blocks shown in FIG. 2A are connected to be able to communicate with each other via a system bus 213. A CPU 201 comprehensively controls the aggregator 101 by, for example, reading a program stored in a storage unit 202 into a memory 203 and executing the program. In addition, the CPU 201 includes blocks for realizing operations of the present embodiment as described later. In addition to a basic program, data, etc. for the aggregator 101 to operate, the storage unit 202 can store, for example, battery utilization plan information 212 of each user 107 utilizing the charge station 102, and store a market transaction program that offers a function to buy and sell power in the power market.

Although, in the example shown in FIG. 2A, the battery utilization plan information 212 of each user 107 is registered in a database configured in the storage unit 202 of the aggregator 101, the battery utilization plan information 212 may be registered in a database configured in a storage unit 234 of the server 105 described later, and the CPU 201 may access the server 105 to obtain the battery utilization plan information 212 when appropriate.

An EMS control unit 204 controls charging and discharging of a plurality of batteries stored in and managed by the charge station 102 via the EMS network 103. For example, the EMS control unit 204 can suppress charging for the plurality of batteries managed in the charge station 102 according to a request for suppression of the power demand from an electric power supplier, and can perform discharging from the plurality of batteries. More specifically, since it is often more necessary to suppress the power demand during the day than at night, the EMS control unit 204 can charge the plurality of batteries at night during which there is a relatively low possibility that suppression of the power demand is requested from the electric power supplier, and can perform discharging from the plurality of batteries, according to a request from the electric power supplier to suppress the power demand during the day.

A network interface (NW I/F) 205 is an interface for enabling communication with the EMS network 103. In addition, a network interface (NW I/F) 206 is an interface for enabling communication with the network 106, and is configured by including, for example, an NIC (Network Interface Card).

In addition, as shown in FIG. 2A, the CPU 201 of the aggregator 101 can include a reception unit 207, an obtaining unit 208, a creation unit 209, an operation unit 210, and a setting unit 211. The reception unit 207 receives the battery utilization plan information 212 pre-registered from a terminal (for example, a mobile phone or a computer) of the user 107 by the NW I/F 206 via the network 106, and stores the battery utilization plan information 212 in the storage unit 202 of the aggregator 101 and/or the storage unit 234 of the server 105.

Here, the battery utilization plan information 212 can include information, such as the timing (date and time) when the battery used by the user 107 is brought into the charge station 102, the time period during which the battery is deposited in the charge station 102, and the timing (date and time) when the charged battery is brought out from the charge station 102. The battery utilization plan information 212 may also include information regarding the date when a battery utilization plan is pre-registered by the user 107. In addition, the battery utilization plan information may also include information of battery characteristics, such as the capacity and charging and discharging speed of a battery brought into the charge station 102 by the user 107. Furthermore, when a vehicle with a power generation unit is brought into the charge station 102 by the user 107, the battery utilization plan information may also include information such as a possible power generation amount thereof.

The obtaining unit 208 obtains the battery utilization plan information 212 stored in the storage unit 202 of the aggregator 101 and/or the storage unit 234 of the server 105. The creation unit 209 creates an operation plan for the battery (power unit) based on the battery utilization plan information 212 obtained by the obtaining unit 208. The operation unit 210 operates each battery by controlling the charging and discharging of each battery stored in and managed by the charge station 102 by the EMS control unit 204 via the EMS network 103. The setting unit 211 sets an incentive to the user 107 according to the battery utilization plan information 212 obtained by the obtaining unit 208.

FIG. 2B is a diagram showing the configuration of the charge station 102 that stores and manages the plurality of batteries. Each of blocks shown in FIG. 2B are connected to be able to communicate with each other via a system bus 228. A CPU 221 comprehensively controls the charge station 102 by, for example, reading a program stored in a storage unit 225 into a memory 222 and executing the program. The storage unit 225 stores a basic program, data, etc. for operating a charging and discharging system 227 that performs charging and discharging of each of the plurality of batteries, and parameters, data, etc. required for controlling the charging and discharging of each battery.

A network interface (NW I/F) 223 is an interface for enabling communication with the EMS network 103. A network interface (NW I/F) 224 is an interface for enabling communication with the network 106, and is configured by including, for example, an NIC. In addition, an EMS control unit 226 controls the charging and discharging system 227 that performs charging and discharging of each of the plurality of batteries, according to a control instruction transmitted from the EMS control unit 204 of the aggregator 101 via the EMS network 103.

FIG. 2C is a diagram showing the configuration of the server 105. Each of blocks shown in FIG. 2C are connected to be able to communicate with each other via a system bus 235. A CPU 231 comprehensively controls the server 105 by, for example, reading a program stored in the storage unit 234 into a memory 232 and executing the program. In addition to a basic program and data, etc. for the server 105 to operate, the storage unit 234 can store, for example, the battery utilization plan information 212 received by the aggregator 101 (reception unit 207). A network interface (NW I/F) 233 is an interface for enabling communication with the network 106, and is configured by including, for example, an NIC.

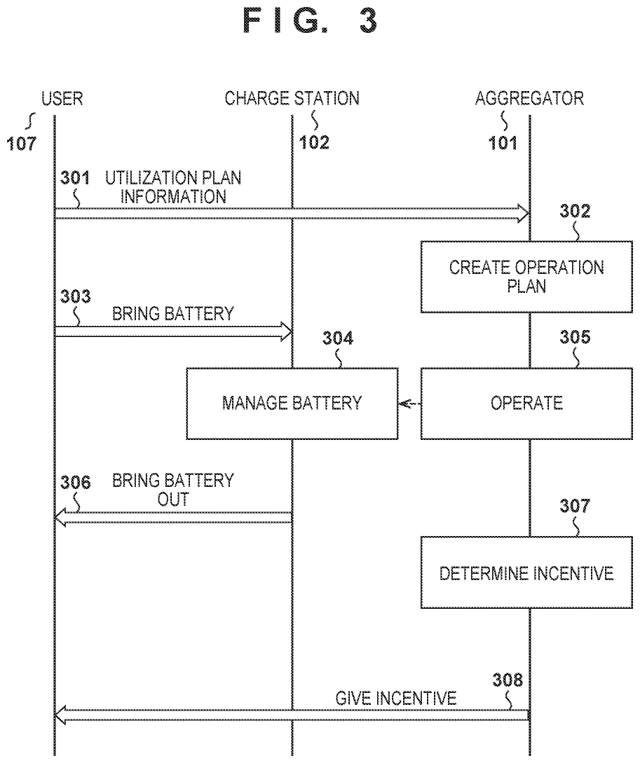

Next, referring to FIG. 3, a description will be given of processing performed among the aggregator 101, the charge station 102, and the user 107 in the VPP system shown in FIG. 1. FIG. 3 is a sequence diagram showing the processing performed among the aggregator 101, the charge station 102, and the user 107. In Step 301, the battery utilization plan information is transmitted to the aggregator 101 from the user 107 via the network 106 by the terminal, such as a mobile phone or a computer, of the user 107. Thereafter, in Step 302, the aggregator 101 creates an operation plan for operating a battery deposited in the charge station 102 by the user 107, based on the battery utilization plan information transmitted from the user 107. The operation plan indicates, for example, a plan for the amount of power available to respond to a request from the electric power supplier 104 at each time.

When a battery is brought into the charge station 102 by the user 107 in Step 303, the battery is managed in the charge station 102 (Step 304). Then, the aggregator 101 performs the operation of each battery managed in the charge station 102 based on the operation plan created in Step 302 (Step 305), and responds to a request from the electric power supplier 104. When the battery is brought out by the user 107 in Step 306, the aggregator 101 determines an incentive for the user 107 (Step 307), and gives the determined incentive to the user 107 (Step 308).

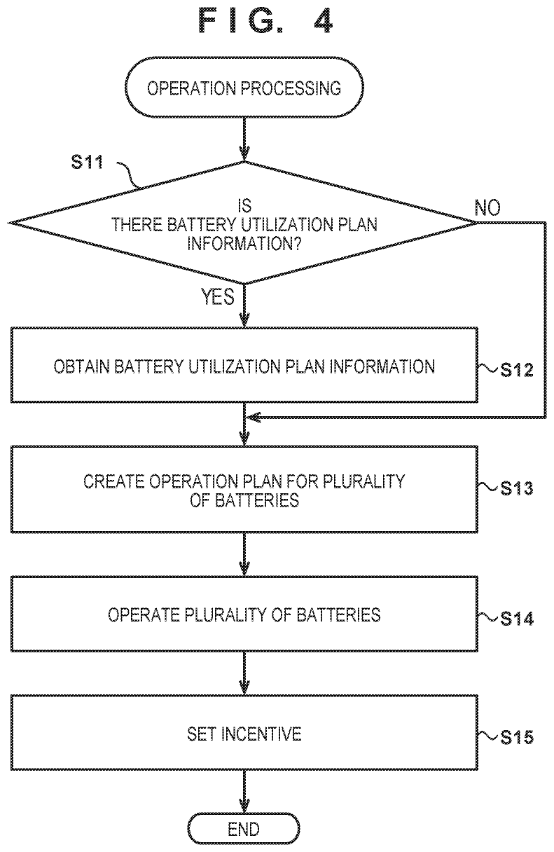

FIG. 4 is a flowchart showing operation processing of a plurality of batteries in the charge station 102. The operation processing shown in FIG. 4 can be performed by the CPU 201 of the aggregator 101.

In S11, the CPU 201 confirms whether or not the battery utilization plan information pre-registered by the user 107 is stored in the storage unit of the aggregator 101 or the storage unit of the server. When the battery utilization plan information by the user 107 is stored, it proceeds to S12, and the stored battery utilization plan information is obtained. On the other hand, when the battery utilization plan information is not stored, it proceeds to S13.

In S13, the CPU 201 creates operation plans for the plurality of batteries stored in and managed by the charge station 102, based on the battery utilization plan information obtained in S12. As described above, the operation plan represents, for example, the plan for the amount of power available to respond to a request from the electric power supplier 104, and the amount of power available to respond can include, for example, a reducible amount of the amount of power used in the charge station 102, a possible output amount from the charge station 102, etc. The possible output amount can include, for example, the amount of power that can be discharged from the plurality of stored and managed batteries, and the amount of power that can be generated by a vehicle with a power generation unit, etc. In addition, the operation plan can be created, for example, on a daily, weekly, or monthly basis, and can be created for each battery stored in and managed by the charge station 102.

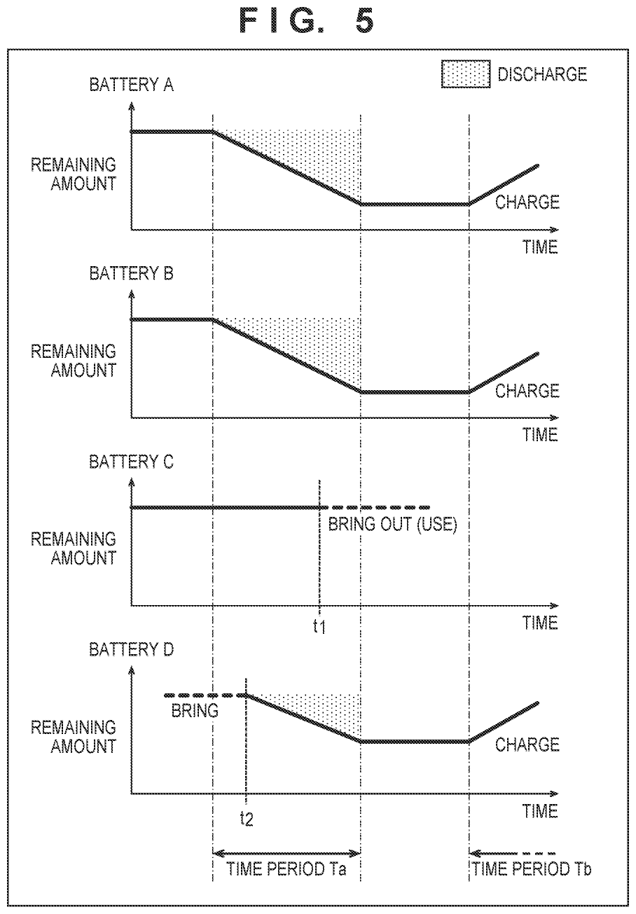

FIG. 5 is a diagram showing an example of the operation plans for a plurality of batteries on a predetermined day, and the operation plans for batteries A to D that may be stored in and managed by the charge station 102 are shown. For the batteries A and B, since there is no utilization schedule for the predetermined day by the user 107 in the battery utilization plan information obtained in S12, the operation plans can be created that the power accumulated in the batteries can be discharged as indicated by hatched portions in a time period Ta during which it is anticipated that there is a request from the electric power supplier 104, and the batteries are to be charged in a time period Tb during which it is anticipated that the power demand amount in the power market is relatively low.

On the other hand, for the battery C, since there is a plan that the user 107 brings it out from the charge station 102 and utilizes it at time t₁ in the battery utilization plan information obtained in S12, an operation plan can be created that discharging from the battery C is not performed during the time period Ta. In addition, for the battery D, since there is a plan that the user 107 brings it into the charge station 102 at time t2 in a state where charging is completed (a fully charged state) in the battery utilization plan information obtained in S12, an operation plan can be created that, as indicated by a hatched portion, discharging can be performed from the time t2.

Here, the timing of starting discharging and the timing of starting charging in each battery may be mutually shifted among the plurality of batteries, according to the power amount anticipated to be requested from the electric power supplier 104. In addition, anticipation of the power amount requested from the electric power supplier 104 is performed in consideration of, for example, the day of the week, weather forecast (also including air temperature and humidity), etc. of a target day for which an operation plan is to be created, based on requests (past records) from the electric power supplier 104 in the past.

In S14, the CPU 201 controls the charging and discharging of the plurality of batteries in the charge station 102, and operates the plurality of batteries, based on the operation plans created in S13. In S15, an incentive is set for the user 107 who has performed pre-registration of the battery utilization plan. The set incentive is associated with the user 107, and stored in the storage unit 202 of the aggregator 101 and/or the storage unit 234 of the server 105. Since it is desired in the VPP system to operate the plurality of batteries in the charge station 102 in a more planned manner, it is preferable that accurate utilization plans are promptly obtained from the users 107 of the batteries. As in the present embodiment, by giving the incentive to the user 107 who has performed pre-registration of the battery utilization plan information, it is possible to encourage the user 107 to promptly pre-register the accurate utilization plan of the battery, and to perform the operation of the battery in a more planned manner.

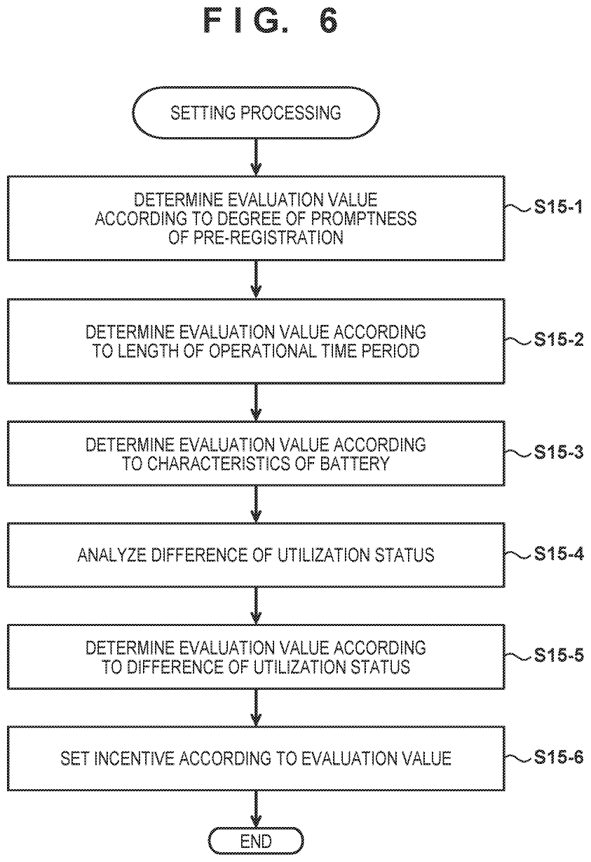

Next, setting processing of the incentive performed in the above-described S15 will be described. FIG. 6 is a flowchart showing the setting processing of the incentive. In the setting processing of the incentive in the present embodiment, for example, the higher the degree of operational freedom and operational value of the battery in the VPP system are, the higher the incentive can be set (determined). In the following description, an example will be described in which the incentive is set to a specific user 107 among the plurality of users 107. In addition, processing in FIG. 6 is performed by the CPU 201 of the aggregator 101.

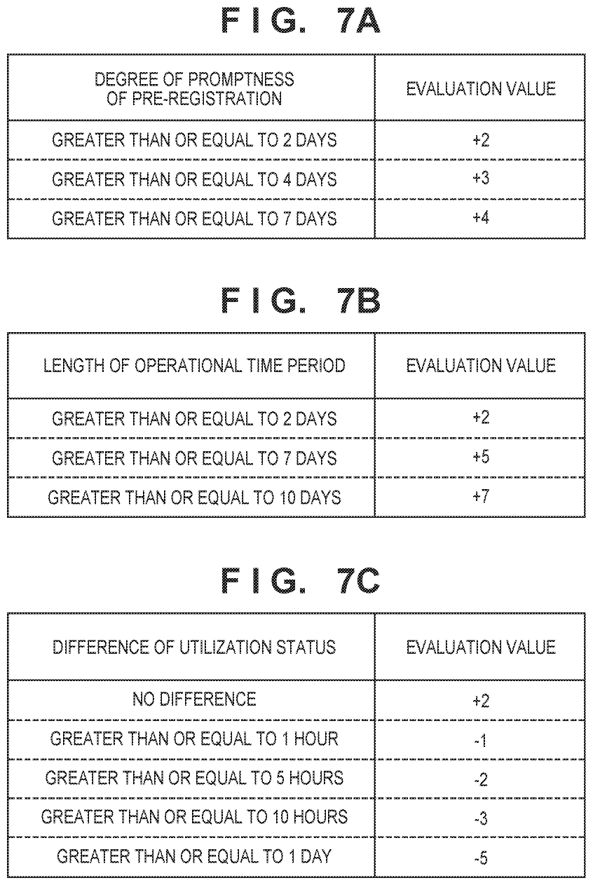

In S15-1, the CPU 201 confirms (obtains) the date (pre-registration date) when the battery utilization plan was pre-registered by the user 107, and determines an evaluation value according to the degree of promptness of the pre-registration of the battery utilization plan. The evaluation value is an index for evaluating the user 107, and can also be said to be an index (degree of reliability) about the reliability for the user 107. For example, when the pre-registration date of the battery utilization plan is before a scheduled date (time) for creating an operation plan about a target operation date of the battery, and the earlier the pre-registration date of the battery utilization plan (that is, the greater the difference between the pre-registration date and the target operation date), the higher the evaluation value is increased by the CPU 201. As shown in FIG. 7A, information indicating the amount for increasing and decreasing the evaluation value for the difference between the pre-registration date of the battery utilization plan and the target operation date (the degree of promptness of pre-registration (number of days)) may be created in advance, and the evaluation value for the user 107 may be determined based on this information. Here, the information shown in FIG. 7A is merely an example, and the content of the information may be changed appropriately.

In S15-2, the CPU 201 confirms (obtains) the length of an operational time period of the battery in the battery utilization plan pre-registered by the user 107, and determines the evaluation value according to the length of the operational time period. The determination of the evaluation value in S15-2 can be accumulatively (additionally) performed on the evaluation value determined in S15-1. The operational time period of a battery is, for example, a time period after the user 107 brings the battery into the charge station 102 until the user 107 brings out the battery, and is specifically a time period during which the battery deposited in the charge station 102 by the user 107 can be freely operated in the VPP system. For example, as shown in FIG. 7B, the CPU 201 can create in advance information indicating the amount for increasing and decreasing the evaluation value for the length of the operational time period of a battery, and can determine the evaluation value for the user 107 based on this information such that the longer the operational time period of the battery, the higher the evaluation value is increased. Here, the information shown in FIG. 7B is merely an example, and the content of the information may be changed appropriately.

In addition, the CPU 201 may determine the evaluation value for the user 107 according to the matching degree between the operational time period of a battery, and a time period (hereinafter may be called “the operation required time period”) during which the operation of the battery in the VPP system is required. The operation required time period of a battery is, for example, a time period during which power adjustment is requested from the electric power supplier 104, that is, a time period during which power leveling is performed by controlling the charging and discharging of the battery according to a requirement from the electric power supplier 104, and the evaluation value for the user 107 may be determined such that the higher the matching degree between the operational time period of the battery and the operation required time period, the higher the evaluation value is increased.

In S15-3, the CPU 201 confirms (obtains) the characteristics of the battery that is a target of the battery utilization plan pre-registered by the user 107, and determines the evaluation value according to the characteristics of the battery. The determination of the evaluation value in S15-3 may be accumulatively (additionally) performed on the evaluation value determined in S15-1 to S15-2. For example, when the battery is the latest model, the battery capacity is high, and the charging and discharging speed is fast, the degree of operational freedom of the battery in the VPP system is expanded for that amount. Therefore, the CPU 201 can determine the evaluation value for the user 107 such that the higher the battery capacity as the battery characteristics, the higher the evaluation value, and the faster the charging and discharging speed of the battery, the higher the evaluation value.

In S15-4, the CPU 201 analyzes whether or not actual utilization of the battery by the user 107 was performed according to the pre-registered battery utilization plan. That is, the CPU 201 analyzes whether or not there is a difference between the actual utilization status (utilization mode) of the battery by the user 107 and the battery utilization plan. Hereinafter, the difference between the actual utilization status of the battery and the battery utilization plan may be simply called “the difference in the utilization status.” In S15-5, the CPU 201 determines the evaluation value according to the difference in the utilization status analyzed in S15-4. The determination of the evaluation value in S15-5 can be accumulatively (additionally) performed on the evaluation value determined in S15-1 to S15-3. Note that the order of Steps S15-1 to S15-5 for respectively determining the evaluation values for the user 107 may be changed appropriately.

For example, as shown in FIG. 7C, the CPU 201 can create in advance information indicating the amount for increasing and decreasing the evaluation value for the difference in the utilization status, and can determine the evaluation value for the user 107 based on this information. In an example shown in FIG. 7C, when there is no difference between the actual utilization status of the battery and the battery utilization plan, the CPU 201 increases the evaluation value for the user 107, assuming that the battery was utilized according to the battery utilization plan. On the other hand, in a case where the date and time when the battery was actually brought into the charge station 102 is later than the battery utilization plan pre-registered by the user 107, and in a case where there is a difference in the utilization status, such as in a case where the date and time when the battery was actually brought out from the charge station 102 is early, the CPU 201 may decrease the evaluation value for the user 107 according to the difference in the utilization status. Here, the information shown in FIG. 7C is merely an example, and the content of the information may be change appropriately.

In S15-6, the CPU 201 sets an incentive to be given to the user 107, based on the evaluation value determined in S15-1 to S15-5. The incentive is a reward given to the user 107. The incentive set in S15-6 can be associated with (mapped to) the user 107 and stored in the storage unit of the server 105, and can be transmitted (notified) to the terminal (a mobile phone or a computer) of the user 107 via the network 106.

Examples of the incentive include, for example, favorable treatments for the reduction rate (discount rate) of cost for charging a battery in the charge station 102, and for the number of points given to the user 107 when a point service is adopted. In addition, when a battery utilized by the user 107 is a battery rented from the charge station 102, the favorable treatment of the reduction rate of a rental fee, etc. may be set as the incentive, and when the charge station 102 functions as a parking lot for electric vehicles including batteries, the favorable treatment of the discount rate of a parking fee (parking lot utilization fee), etc. may be set as the incentive. Furthermore, the CPU 201 may set the incentive for the user 107 according to a profit obtained by operation of the battery deposited in the charge station 102 by the user 107. For example, the amount of a predetermined percentage of the profit obtained by the operation of the battery may be set as the incentive for the user 107.

As described above, in the present embodiment, it is possible to encourage the user 107 to promptly pre-register a more accurate battery utilization plan by setting the incentive to the user 107 who has performed pre-registration of the battery utilization plan. Accordingly, it is possible to perform a planned operation of the battery in the charge station 102 in the VPP system.

Here, in the present embodiment, although the example has been described in which the incentive is set (determined) according to the battery utilization plan pre-registered by the user 107 in the VPP system, setting the incentive in this manner is not limited to the VPP system. For example, in a sharing system of a vehicle mounting a power unit, such as a battery and a generator, the incentive may be set according to the utilization plan of the vehicle (including the scheduled date and time to start utilizing the vehicle, the scheduled date and time to return the vehicle, etc.) pre-registered by a user. In addition, in a sharing system of the power unit itself, such as a battery, the incentive may be set according to the utilization plan of the power unit pre-registered by the user. In such a sharing system, the reduction rate of a fee (sharing fee) required for sharing of the vehicle or the power unit, etc. may be included as the incentive.

Furthermore, the VPP system can be operated in conjunction with a sharing system. For example, in a case where the power supply demand from the power unit to a system (a discharge requirement from the power unit) is low, such as a case where there is a surplus of grid power, if the operation in the sharing system is possible, the operation in the sharing system is preferentially performed, so as to consume the power of the power unit. Accordingly, it is possible to ensure the chargeable capacity of the power unit to increase the amount of power that can be drawn from the grid. On the other hand, in a case where the electricity fee for charging the power unit soars, such as a case of shortage of the system power, and it is determined that it is more economically profitable to supply power to the grid power than to operate in the sharing system, the operation in the VPP system is preferentially performed. In this manner, when only the VPP system is operated, although “drawing of surplus power from the grid”, such as charging the power unit, is performed at the time of surplus of the grid power, and “supply of power to the grid”, such as discharging from the power unit, is performed at the time of shortage of the grid power, by using this in conjunction with the operation of the sharing system, the degree of operational freedom of the power unit can be further increased.

### SUMMARY OF EMBODIMENT

The power management system of the above-described embodiment is a power management system for managing a power unit, the power management system comprising an obtaining unit (for example, 208) that obtains utilization plan information of the power unit pre-registered by a user of the power unit, a creation unit (for example, 209) that creates an operation plan of the power unit based on the utilization plan information obtained by the obtaining unit, and a setting unit (for example, 211) that sets an incentive to the user according to the utilization plan information obtained by the obtaining unit. With such a configuration, it is possible to encourage the user to promptly pre-register more accurate utilization plan information of the power unit, and it is possible to operate the power unit in a more planned manner.

In addition, the power unit includes any of an in-vehicle battery, a removable portable battery, and an in-vehicle power generation unit. With such a configuration, the operation of the in-vehicle battery, the removable portable battery, and the in-vehicle power generation unit can be performed in a more planned manner.

In addition, the setting unit sets the incentive to the user according to the difference between the utilization plan information obtained by the obtaining unit, and an actual utilization status of the power unit by the user. With such a configuration, since it is more likely that the user utilizes the power unit according to the pre-registered utilization plan information, the operation of the power unit can be performed in a more planned manner.

In addition, the setting unit sets the incentive to the user according to the timing when the utilization plan information was pre-registered. With such a configuration, since it is more likely that the user promptly pre-registers the utilization plan information, the operation of the power unit can be performed in a more planned manner.

In addition, the setting unit sets the incentive to the user according to the length of an operational time period of the power unit determined from the utilization plan information. With such a configuration, since the longer the operational time period of the power unit, the higher the degree of operational freedom of the power unit, the operation of the power unit can be performed in a more planned manner.

In addition, the setting unit sets the incentive to the user according to the matching degree between the operational time period and a time period during which operation of the power unit is required. With such a configuration, since it is more likely that the user utilizes the power unit according to the pre-registered utilization plan information, the operation of the power unit can be performed in a more planned manner.

In addition, the setting unit sets the incentive to the user according to the characteristics of the power unit that is a target of the utilization plan information. With such a configuration, since the better the characteristics of the power unit, the higher the degree of operational freedom of the power unit, the operation of the power unit can be performed in a more planned manner.

In addition, the setting unit sets the incentive to the user according to a profit obtained by the operation of the power unit. With such a configuration, it is possible to encourage the user to positively participate in the operation of the power unit, and the operation of the power unit can be performed in a more planned manner.

In addition, an operation unit (for example, 210) that performs operation of the power unit based on the operation plan created by the creation unit is further included. With such a configuration, the operation of the power unit can be efficiently performed.

In addition, the operation unit controls charging and discharging of the power unit as the operation of the power unit. With such a configuration, the operation of the power unit can be efficiently performed.

In addition, the operation unit performs sharing of a vehicle mounting the power unit as the operation of the power unit. With such a configuration, in the sharing of the vehicle mounting the power unit, the operation of the vehicle can be performed in a more planned manner.

In addition, the operation unit performs sharing of the power unit as the operation of the power unit. With such a configuration, in the sharing of the power unit, the operation of the power unit can be performed in a more planned manner.

In addition, the setting unit sets the incentive regarding a favorable treatment of at least one of a parking lot utilization fee, a charging fee, and a sharing fee. With such a configuration, since it is more likely that the user promptly pre-registers more accurate utilization plan information, the operation of the power unit can be performed in a more planned manner.

The present invention is not limited to the above-described embodiments, and various changes and modifications can be made within the spirit and scope of the present invention. Therefore, to apprise the public of the scope of the present invention, the following claims are made.

1. A power management system for managing a power unit, the power management system comprising:
an obtaining unit configured to obtain utilization plan information of the power unit pre-registered by a user of the power unit;
a creation unit configured to create an operation plan of the power unit based on the utilization plan information obtained by the obtaining unit; and
a setting unit configured to set an incentive to the user according to the utilization plan information obtained by the obtaining unit.

2. The power management system according to claim 1, wherein the power unit includes any of an in-vehicle battery, a removable portable battery, and an in-vehicle power generation unit.

3. The power management system according to claim 1, wherein the setting unit sets the incentive to the user according to the difference between the utilization plan information obtained by the obtaining unit, and an actual utilization status of the power unit by the user.

4. The power management system according to claim 1, wherein the setting unit sets the incentive to the user according to timing when the utilization plan information was pre-registered.

5. The power management system according to claim 1, wherein the setting unit sets the incentive to the user according to the length of an operational time period of the power unit determined from the utilization plan information.

6. The power management system according to claim 5, wherein the setting unit sets the incentive to the user according to matching degree between the operational time period and a time period during which operation of the power unit is required.

7. The power management system according to claim 1, wherein the setting unit sets the incentive to the user according to characteristics of the power unit that is a target of the utilization plan information.

8. The power management system according to claim 1, wherein the setting unit sets the incentive to the user according to a profit obtained by operation of the power unit.

9. The power management system according to claim 1, further comprising an operation unit that performs operation of the power unit based on the operation plan created by the creation unit.

10. The power management system according to claim 9, wherein the operation unit controls charging and discharging of the power unit as the operation of the power unit.

11. The power management system according to claim 9, wherein the operation unit performs sharing of a vehicle mounting the power unit as the operation of the power unit.

12. The power management system according to claim 9, wherein the operation unit performs sharing of the power unit as the operation of the power unit.

13. The power management system according to claim 1, wherein the setting unit sets the incentive regarding a favorable treatment of at least one of a parking lot utilization fee, a charging fee, and a sharing fee.

14. A power management method of managing a power unit, the method comprising:
obtaining utilization plan information of the power unit pre-registered by a user of the power unit;
creating an operation plan of the power unit based on the utilization plan information obtained in the obtaining of the utilization plan information of the power unit; and
setting an incentive to the user according to the utilization plan information obtained in the obtaining of the utilization plan information of the power unit.

15. A non-transitory computer-readable storage medium storing a program for causing a computer to function as each units of a power management system according to claim 1.
